(19) United States
(12) Patent Application Publication
(10) Pub. No.: US 2026/0195736 A1
(43) Pub. Date: Jul. 9, 2026

(54) CONTROL METHOD, DEVICE, AND RECORDING MEDIUM

(71) Applicant: Panasonic Intellectual Property Management Co., Ltd., Osaka (JP)

(72) Inventors: Takeru KOIE, Saitama (JP); Kakuya YAMAMOTO, Hyogo (JP); Yuji UNAGAMI, Osaka (JP)

(21) Appl. No.: 19/556,506

(22) Filed: Mar. 4, 2026

Related U.S. Application Data
(63) Continuation of application No. PCT/JP2024/032476, filed on Sep. 11, 2024.
(60) Provisional application No. 63/538,581, filed on Sep. 15, 2023.

(51) Int. Cl. G06Q 20/36

(52) U.S. Cl. CPC G06Q 20/367

(57) ABSTRACT

A control method is a control method performed by a device, and includes obtaining first digital content generated by a first terminal of a first user, identifying one or more items of first identification information associated with one or more items of second digital content that may have been used in generation of the first digital content by the first terminal of the first user, and outputting the one or more items of first identification information identified.

### CROSS REFERENCE TO RELATED APPLICATIONS

This is a continuation application of PCT International Application No. PCT/JP2024/032476 filed on September 11, 2024, designating the United States of America, which is based on and claims priority of U.S. Provisional Patent Application No. 63/538581 filed on September 15, 2023. The entire disclosures of the above-identified applications, including the specifications, drawings and claims are incorporated herein by reference in their entirety.

### FIELD

The present disclosure relates to a control method, a device, and a recording medium.

### BACKGROUND

Patent Literature (PTL) 1 discloses a technique for buying and selling non-fungible tokens (NFTs) for proving the authenticity of digital content or the owner of digital content.

### Citation List

### Patent Literature

PTL 1: Japanese Patent No. 7129579

### SUMMARY

### Technical Problem

The present disclosure provides a control method and the like capable of easily identifying candidates for digital content used to generate digital content.

### Solution to Problem

A control method according to one aspect of the present disclosure is a control method performed by a device, the control method including obtaining first digital content generated by a first terminal of a first user, identifying one or more items of first identification information associated with one or more items of second digital content that may have been used in generation of the first digital content by the first terminal of the first user, and outputting the one or more items of first identification information identified.

A device according to one aspect of the present disclosure includes a processor and a memory. Using the memory, the processor obtains first digital content generated by a first terminal of a first user, identifies one or more items of first identification information associated with one or more items of second digital content that may have been used in generation of the first digital content by the first terminal of the first user, and outputs the one or more items of first identification information identified.

Note that these comprehensive or specific aspects may be realized by a system, a device, an integrated circuit, a computer program, or a computer-readable recording medium such as a CD-ROM, or may be implemented by any desired combination of systems, devices, integrated circuits, computer programs, and recording media.

### Advantageous Effects

According to the control method and the like of the present disclosure, candidates for digital content used to generate digital content can be identified with ease.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an overview of a system according to an embodiment.

FIG. 2 is a block diagram illustrating the configuration of the system according to the embodiment.

FIG. 3 is a block diagram illustrating an example of the configuration of a service server according to the embodiment.

FIG. 4 is a block diagram illustrating an example of the configuration of a management server according to the embodiment.

FIG. 5 is a sequence chart illustrating an example of processing for converting digital content to an NFT according to an embodiment.

FIG. 6 is a sequence chart illustrating an example of details of a primary NFT registration phase according to an embodiment.

FIG. 7 is a sequence chart illustrating an example of details of an N-ary registration phase according to an embodiment.

FIG. 8 is a diagram illustrating an example of a UI.

FIG. 9 is an explanatory diagram illustrating the data structure of a blockchain.

FIG. 10 is an explanatory diagram illustrating the data structure of transaction data.

FIG. 12 is an explanatory diagram illustrating processing related to the execution of a smart contract.

### DESCRIPTION OF EMBODIMENT

### Underlying Knowledge Forming Basis of Present Disclosure

Recently, various types of digital content (content data) are being managed in association with NFTs. Using an NFT makes it possible to ensure the authenticity of the digital content and easily identify the owner of the digital content.

When considering the buying and selling of virtual digital content located in a metaverse space, there is a need for a mechanism for distributing profit gained from selling digital content not only to the parties involved in the digital content but also to other parties involved in digital content that is used to generate the digital content. For this mechanism, for example, when new digital content is generated based on other digital content, it is conceivable to include the NFT ID of an NFT associated with the other digital content in an NFT associated with the new digital content. In this manner, the NFT of the newly-generated digital content includes the NFT ID of the NFT of the other digital content, and thus the relationship between the newly-generated digital content and the other digital content can be managed through a blockchain using the NFT of the newly-generated digital content.

However, when generating an NFT of new digital content, the NFT ID of the NFT of other digital content used to generate new digital content is required. To that end, it is necessary for the creator to declare the other digital content they used to generate new digital content, which means the creator must take the trouble to make the declaration.

This led to the discovery of a control method and the like capable of easily identifying candidates for digital content used to generate digital content.

A control method according to a first aspect of the present disclosure is a control method performed by a device, the control method including obtaining first digital content generated by a first terminal of a first user, identifying one or more items of first identification information associated with one or more items of second digital content that may have been used in generation of the first digital content by the first terminal of the first user, and outputting the one or more items of first identification information identified.

Accordingly, one or more items of first identification information associated with one or more items of second digital content that may have been used when generating the first digital content can be used as candidates for the digital content used when generating the first digital content. By presenting one or more items of first identification information to a first user who is the creator of the first digital content, for example, the first user can easily identify the digital content used when generating the first digital content, and can easily declare the digital content used when generating the first digital content.

A control method according to a second aspect of the present disclosure is the control method according to the first aspect, wherein the one or more items of first identification information are identified based on a history of digital content obtained from the device by the first terminal.

Accordingly, one or more items of first identification information associated with one or more items of second digital content that are likely to have been used when generating first digital content can be identified with ease.

A control method according to a third aspect of the present disclosure is the control method according to the first or second aspect, wherein the first digital content includes one or more items of second identification information, and the one or more items of first identification information are identified based on the one or more items of second identification information included in the first digital content.

Accordingly, one or more items of first identification information associated with one or more items of second digital content that are likely to have been used when generating first digital content can be identified with ease.

A control method according to a fourth aspect of the present disclosure is the control method according to any one of the first to third aspects, further including generating a list including the one or more items of first identification information, the list being a list for querying the first user about one or more items of third digital content used when generating the first digital content, and sending the list to the first terminal.

Accordingly, one or more items of first identification information can be presented as a list to the first user who is the creator of the first digital content. The first user can therefore easily identify the digital content used when generating the first digital content from the list, and can easily declare the digital content used when generating the first digital content.

A control method according to a fifth aspect of the present disclosure is the control method according to the fourth aspect, further including receiving a response to the list from the first terminal, and identifying, in accordance with the response, one or more items of third identification information corresponding to the one or more items of third digital content.

Accordingly, a response from a first user can be used as a declaration of digital content used when generating first digital content, and one or more items of third digital content used when generating first digital content can be identified with ease.

A control method according to a sixth aspect of the present disclosure is the control method according to the fifth aspect, further including generating transaction data including the first digital content and the one or more items of third identification information, and causing a blockchain system to issue a non-fungible token (NFT) corresponding to the first digital content, by sending the transaction data to the blockchain system. The NFT includes the one or more items of third identification information.

Accordingly, an NFT associated with the first digital content, the NFT including one or more items of third identification information associated with one or more items of third digital content, can be generated with ease.

A control method according to a seventh aspect of the present disclosure is the control method according to the sixth aspect, further including obtaining an NFT ID of the NFT from the blockchain system and storing the NFT ID in association with the first digital content.

Accordingly, the first digital content and the NFT ID of the NFT issued by the blockchain system can be stored in association with each other.

A control method according to an eighth aspect of the present disclosure is the control method according to any one of the fourth to seventh aspects, wherein the one or more items of first identification information include fourth identification information and fifth identification information, the fourth identification information is associated with fourth digital content, the fifth identification information is associated with fifth digital content, the fourth digital content is more likely than the fifth digital content to have been used to generate the first digital content, and the list further includes information indicating that the fourth digital content is more likely than the fifth digital content to have been used to generate the first digital content.

Accordingly, a list including fourth identification information of fourth digital content that is likely to have been used and the fifth identification information of the fifth digital content that is less likely to have been used than the fourth digital content can be presented to the first user who is the creator of the first digital content. Accordingly, the first user can easily identify the digital content used when generating the first digital content from the list, and can easily declare the digital content used when generating the first digital content.

A device according to a ninth aspect of the present disclosure includes a processor and a memory. Using the memory, the processor obtains first digital content generated by a first terminal of a first user, identifies one or more items of first identification information associated with one or more items of second digital content that may have been used in generation of the first digital content by the first terminal of the first user, and outputs the one or more items of first identification information identified.

Accordingly, one or more items of first identification information associated with one or more items of second digital content that may have been used when generating the first digital content can be used as candidates for the digital content used when generating the first digital content. By presenting one or more items of first identification information to a first user who is the creator of the first digital content, for example, the first user can easily identify the digital content used when generating the first digital content, and can easily declare the digital content used when generating the first digital content.

A recording medium according to a tenth aspect of the present disclosure is a non-transitory computer-readable recording medium having recorded thereon a program for causing a computer to execute a control method performed by a device. The control method includes obtaining first digital content generated by a first terminal of a first user, identifying one or more items of first identification information associated with one or more items of second digital content that may have been used in generation of the first digital content by the first terminal of the first user, and outputting the one or more items of first identification information identified.

Note that these comprehensive or specific aspects may be realized by a system, a device, an integrated circuit, a computer program, or a computer-readable recording medium such as a CD-ROM, or may be implemented by any desired combination of systems, devices, integrated circuits, computer programs, and recording media.

An embodiment will be described hereinafter with reference to the drawings. Note that the following embodiment describes specific examples of the present disclosure. In other words, the numerical values, shapes, materials, constituent elements, arrangements and connection states of constituent elements, steps, orders of steps, and the like in the following embodiment are merely examples, and are not intended to limit the present disclosure. Additionally, of the constituent elements in the following embodiment, constituent elements not denoted in the independent claims indicating the broadest interpretation are not absolutely necessary for solving the problem of the present disclosure, and will instead be described as constituent elements constituting more preferred forms.

### Embodiment

The present embodiment will describe a control method and the like capable of easily identifying candidates for digital content used to generate digital content.

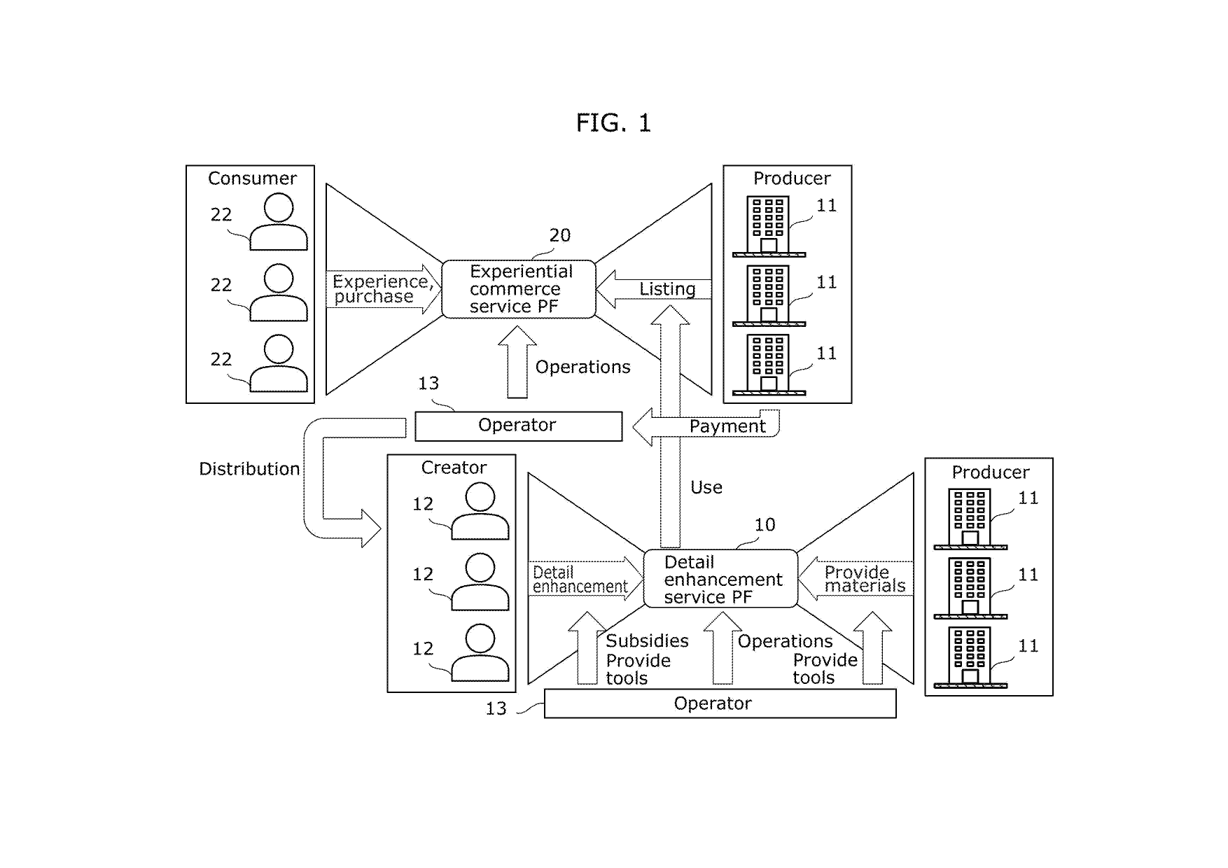

FIG. 1 is a diagram illustrating an overview of a system according to the embodiment.

In FIG. 1, transactions on two platforms are illustrated. The two platforms include detail enhancement service platform 10 and experiential commerce service platform 20. Note that “platform” is denoted as “PF” in the subsequent figures.

Detail enhancement service platform 10 is a platform used to enhance the detail of content expressed by content data. Producer 11 provides the resources of the digital data subject to detail enhancement to detail enhancement service platform 10.

Note that the digital data resources may be, for example, the original data of a three-dimensional object before the detail enhancement. The original data of the three-dimensional object may include information expressing a mesh, a texture, a material, or the like. A “mesh” is information that defines the shape of a three-dimensional object, and is a collection of polygons or vertices. The mesh may include information pertaining to vertex coordinates, surface normals, and UV mapping. A “texture” is information that defines the appearance or texture of the surface of a three-dimensional object. Textures are used to reproduce the appearance of various materials such as wood, metal, fabric, skin, or the like. A “material” is information that defines the physical properties or optical behavior of a three-dimensional object. Materials include color, reflectance, transparency, glossiness, and the like. The digital data resources are an example of design data (design information). The design data is an example of first content data.

Using the digital data resources provided by producer 11, creator 12 makes inputs on a terminal (computer) owned by creator 12 and enhances the detail of the digital data resources. “Detail enhancement” includes processing for increasing the resolution of polygons or vertices that define the shape of a three-dimensional object, processing for increasing the resolution of a texture, processing for assigning textures to vertices that have been increased, processing for increasing the color tone assigned to a texture, and the like. In other words, “detail enhancement” refers to processing that increases the amount of information per unit of volume in a three-dimensional space. A detail-enhanced three-dimensional object has an appearance that better resembles a real object. The detail-enhanced three-dimensional object is stored in detail enhancement service platform 10.

Operator 13 of detail enhancement service platform 10 provides producer 11 with tools for generating digital data resources, provides creator 12 with tools for enhancing the details of digital data resources, and the like. Operator 13 may provide creator 12 with a subsidy to support the detail enhancement processing by creator 12.

Experiential commerce service platform 20 is a platform for buying and selling NFTs corresponding to content data indicating three-dimensional objects. For example, experiential commerce service platform 20 provides a virtual space (a metaverse). In the metaverse, producer 11 can list detail-enhanced three-dimensional objects generated in detail enhancement service platform 10. Through this, in the metaverse, consumer 22 can experience three-dimensional objects listed by producer 11. For example, in an experience, consumer 22 can view three-dimensional objects, hear sounds related to three-dimensional objects, and the like. Additionally, consumer 22 can purchase an NFT corresponding to a three-dimensional object that has been viewed and heard by experiencing the metaverse, and which has been listed in the metaverse.

Note that consumer 22 is not limited to experiencing three-dimensional objects, and may experience two-dimensional images. The two-dimensional images may be two-dimensional still images or two-dimensional moving images. The two-dimensional images may be images captured by a camera, or may be images generated by a person or a computer. The NFT purchased by consumer 22 may be an NFT corresponding to a two-dimensional image.

When consumer 22 purchases an NFT corresponding to a three-dimensional object, producer 11 pays a fee to operator 13. The fee is a brokerage fee for the establishment of a sales contract between producer 11 and consumer 22 by experiential commerce service platform 20. Operator 13 distributes the fee obtained from producer 11 to creator 12 who generated a three-dimensional object corresponding to the NFT traded in the sales contract. This makes it easy to distribute profit generated by experiential commerce service platform 20 to creator 12 who is not participating in experiential commerce service platform 20.

Note that experiential commerce service platform 20 may be operated by operator 13 operating detail enhancement service platform 10. Alternatively, experiential commerce service platform 20 may be operated by an operator different from operator 13 operating detail enhancement service platform 10.

Note that producer 11 participating in detail enhancement service platform 10 may include the same producer as producer 11 participating in experiential commerce service platform 20. Likewise, producer 11 participating in experiential commerce service platform 20 may include the same producer as producer 11 participating in detail enhancement service platform 10.

Detail enhancement service platform 10 and experiential commerce service platform 20 may be the same platform. In other words, detail enhancement service platform 10 and experiential commerce service platform 20 may be implemented in one platform.

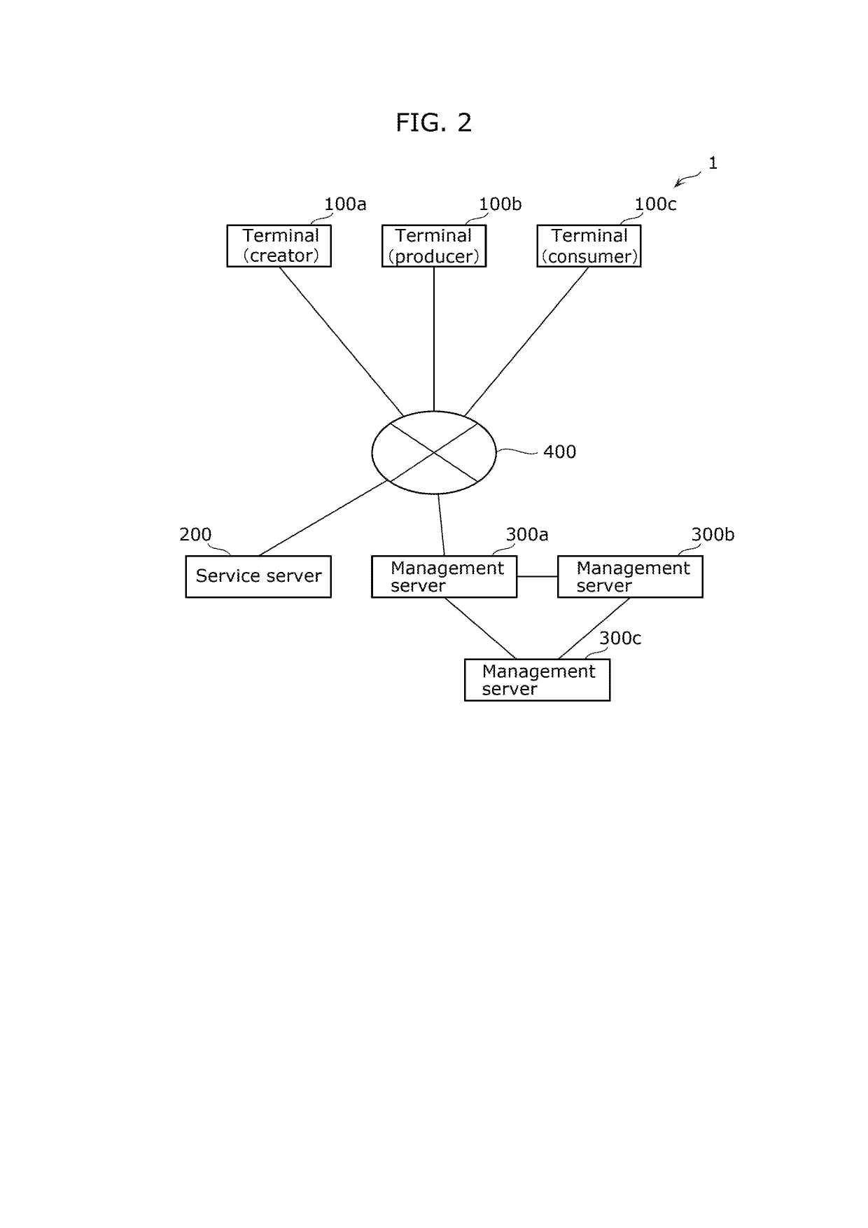

FIG. 2 is a block diagram illustrating the configuration of the system according to the embodiment.

As illustrated in FIG. 2, system 1 includes terminals 100a to 100c, service server 200, and management servers 300a to 300c (also referred to as “management server 300a and the like”). Terminals 100a to 100c, service server 200, and management servers 300a to 300c (also referred to as “management servers 300 and the like”) may all be connected to each other over network 400, may all be communicatively connected directly to each other, or some may be communicatively connected over network 400 while others are communicatively connected directly. Network 400 is, for example, the Internet, a cellular telephone carrier network, or the like, but may be constituted by any communication line or network.

Consumer 22 is a user who experiences a virtual space provided by service server 200. Producer 11 and consumer 22 are users who buy and sell three-dimensional objects in the virtual space.

Service server 200 is a server which is a computer that manages the virtual space. Service server 200 generates the virtual space and provides VR data expressing the virtual space by sending the VR data to the user, which contributes to the user’s experience of the virtual space. The virtual space is, for example, a three-dimensional or two-dimensional virtual space. The virtual space can also be generally referred to as the “metaverse”. The VR data includes image data of an image expressing a scene in the virtual space, and may also include audio data expressing audio in the virtual space. Objects and avatars may be present in the virtual space. The avatars may be associated with people in a real space.

Service server 200 uses terminal 100c to enable consumer 22 to experience the virtual space, for example. Service server 200 sends the VR data to terminal 100c and receives information indicating the position and attitude of a VR device included in terminal 100c (also called “location information”). Service server 200 is an example of a control device.

Note that service server 200 is not limited to providing the virtual space in VR, and may provide the virtual space on a web page. In addition, service server 200 is not limited to providing a virtual space, and may use any form as long as users are provided with a place where NFTs can be viewed. Service server 200 may provide a web page on which NFTs can be viewed.

Service server 200 also makes it possible to execute transactions for objects in the virtual space. In a transaction for an object, for example, when the object is transferred from producer 11 to consumer 22, a cryptographic asset (also called “virtual currency”) is transferred from consumer 22 to producer 11. The cryptographic asset is Bitcoin, Ethereum, or the like, for example, and is managed using a distributed ledger. The transfer of the object is managed using the distributed ledger as an example of the transfer of the NFT.

Management server 300a is a server that manages the transfer of cryptographic assets using a distributed ledger. Management server 300a stores the distributed ledger in storage. When transaction data indicating the transfer of a cryptographic asset is received from a VR device or the like, management server 300a executes processing for storing the received transaction data in the distributed ledger. The transaction data indicating the transfer of the cryptographic asset includes an address, in a distributed ledger system, of the source and destination of the transfer of the cryptographic asset.

Management server 300a can also manage the transfer of objects in the virtual space as the transfer of NFTs by using the distributed ledger. When transaction data indicating the transfer of an NFT is received from a VR device or the like, management server 300a executes processing for storing the received transaction data in the distributed ledger. The transaction data indicating the transfer of the NFT includes an address, in a distributed ledger system, of the source and destination of the transfer of the NFT.

When storing new transaction data in the distributed ledger, management server 300a stores the new transaction data in the distributed ledger in a format based on the type of the distributed ledger. Management server 300a can also exchange communication data with the other management servers 300b and 300c, and send the transaction data to the other management servers 300b and 300c to cause the transaction data to be stored in the distributed ledger held by the other management servers 300b and 300c. When storing the transaction data, the transaction data may be stored after first using a consensus algorithm to form a consensus. The transaction data stored in the distributed ledger is managed using properties such as hash values to prevent tampering (described later).

For example, when the distributed ledger is a blockchain, management server 300a generates a block containing the new transaction data and stores the block in the distributed ledger after using a consensus algorithm to form a consensus with management server 300a and the like for the generated block. Note that the format of the distributed ledger is not limited to the foregoing, and other distributed ledger formats (e.g., IOTA, Hashgraph, or the like) can also be used.

Management servers 300b and 300c are management servers similar to management server 300a, and operate independently from management server 300a.

Note that a management server group including management server 300a and the like can also be referred to as a “distributed ledger network”. Although a case where three of management server 300a and the like are included in the distributed ledger network is described as an example, the number of management server 300a and the like may be four or more.

The VR device is an information processing device that is included in each of terminals 100a to 100c and presents a virtual space to the user who owns each of terminals 100a to 100c, and is an information processing device in the possession of a user (producer 11, creator 12, and consumer 22). The VR device includes a Central Processing Unit (CPU), memory, storage, a display screen, a speaker, sensors, and the like, and processes information by the CPU executing predetermined programs using the memory. The VR device may include a Global Positioning System (GPS) receiver that obtains a position of the VR device on Earth. The VR device is worn on the user’s head, for example, and is generally referred to as “VR goggles” or a “VR headset”.

The VR device receives VR data from service server 200, and uses image data included in the VR data to display an image indicating a scene visible in the virtual space on the display screen to present the scene to the user. The VR device can also present audio data included in the VR data to the user by causing a speaker to output audio heard in the virtual space.

The VR device also obtains location information of the VR device using a sensor (a three-axis accelerometer, a three-axis angular velocity sensor, or the like) and sends that location information to service server 200. The sent location information is used by service server 200 to generate the VR data, and VR data calculated having taken the sent location information into account is then sent.

The VR device also sends information indicating an operation made by the user on the VR device (also called “operation information”) to service server 200. The operation information can include, for example, an operation to select an action from options for actions that can be performed in the virtual space (what is known as a “selection menu”) or the like. The sent operation information is applied to the location information of the user in the virtual space (i.e., the avatar corresponding to the user), and VR data based on the resulting location information and the like is sent thereafter.

Note that each of terminals 100a to 100c need not include a VR device. Each of terminals 100a to 100c may include one or more display devices capable of displaying a place where NFTs provided by service server 200 can be viewed. The one or more display devices are, for example, liquid crystal displays, organic electroluminescence (EL) displays, or the like.

Terminal 100a is an information processing terminal in the possession of creator 12, who is a user. Terminal 100a includes a CPU, memory, storage, a display screen, and the like, and processes information by the CPU executing predetermined programs using the memory. Terminal 100a is, for example, a smartphone, a tablet terminal, a personal computer, or the like.

Terminal 100b is an information processing terminal in the possession of producer 11, who is a user. Terminal 100c is an information processing terminal in the possession of consumer 22, who is a user. Terminals 100b and 100c each have the same configuration as terminal 100a.

Note that a device group including service server 200 and management server 300a and the like is a device group involved in NFT transactions in the virtual space, and can also be referred to as an “NFT network”. Note that the NFTs are not limited to what is specified in the Ethereum standard ERC-721, and may be any token that is not replaceable. The “token” may also be any data issued in association with data or a real object.

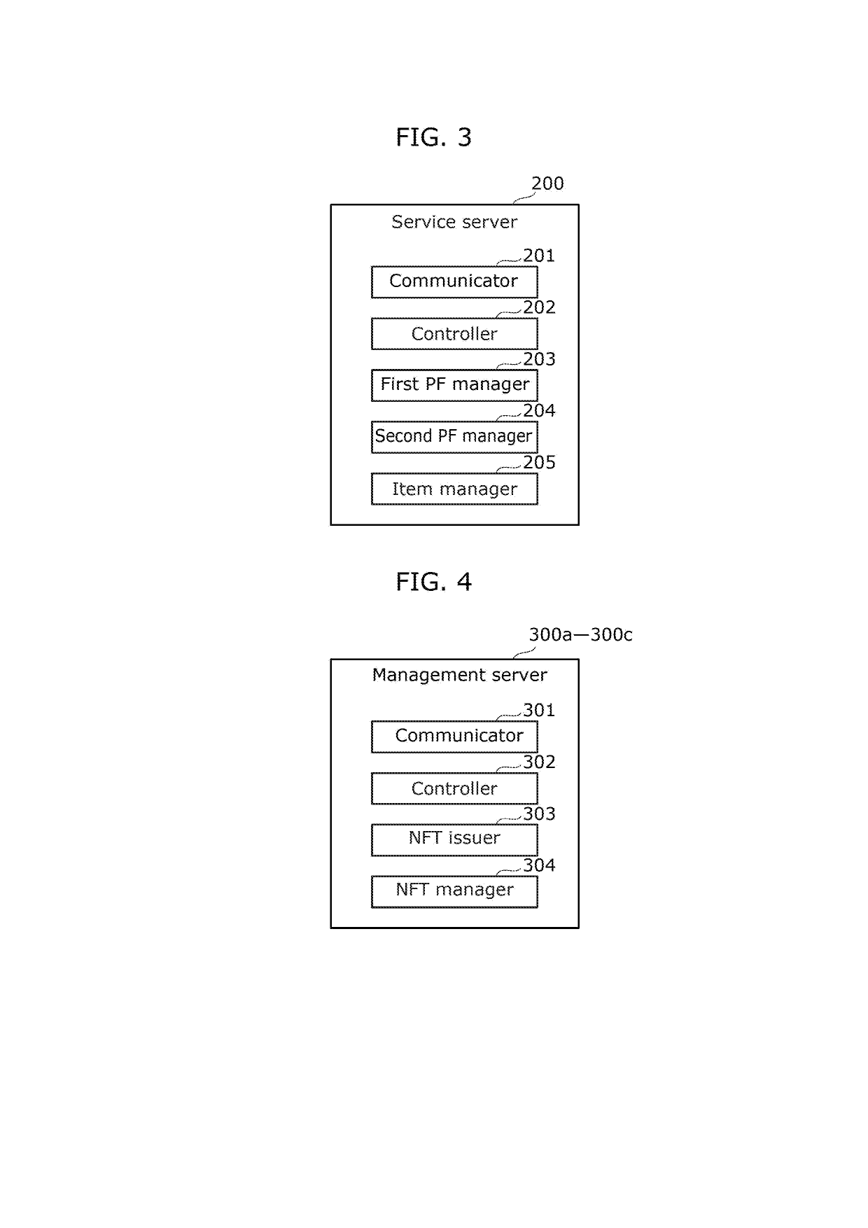

FIG. 3 is a block diagram illustrating an example of the configuration of the service server according to the embodiment.

As illustrated in FIG. 3, service server 200 includes communicator 201, controller 202, first PF manager 203, second PF manager 204, and item manager 205. Communicator 201, controller 202, first PF manager 203, second PF manager 204, and item manager 205 can be realized by a processor (e.g., a Central Processing Unit (CPU)) (not shown) included in service server 200 executing predetermined programs using memory (not shown). Service server 200 is an example of a control device.

Communicator 201 communicates over network 400 with at least one of terminals 100a to 100c and management servers 300a to 300c. Communicator 201 receives information from at least one of terminals 100a to 100c and management servers 300a to 300c. Communicator 201 sends information to at least one of terminals 100a to 100c and management servers 300a to 300c.

Specifically, communicator 201 receives, from terminal 100b of producer 11, design data to be provided to creator 12 on detail enhancement service platform 10. Communicator 201 sends the received design data to terminal 100a of creator 12.

Communicator 201 also receives detail-enhanced content data and a creator ID based on the design data, from terminal 100a of creator 12. The creator ID is identification information for identifying creator 12, and is an example of creator information. Communicator 201 sends the received content data to terminal 100b of producer 11.

Communicator 201 also receives, from terminal 100b of producer 11, content data for listing on experiential commerce service platform 20. Communicator 201 also sends the content data to terminal 100c of consumer 22 in response to a request from terminal 100c of consumer 22. Specifically, communicator 201 sends VR data for providing the metaverse that consumer 22 is experiencing through terminal 100c. The VR data includes the content data.

Communicator 201 also receives, from terminal 100c of consumer 22, an ID of the NFT that consumer 22 purchased in experiential commerce service platform 20, as well as a consumer ID. Communicator 201 receives, from terminal 100b of producer 11, fee information indicating a brokerage fee for the establishment of a sales contract between producer 11 and consumer 22. The sales contract relates to the buying and selling of an NFT on experiential commerce service platform 20.

Additionally, communicator 201 sends a registration request for registering the NFT with management servers 300a to 300c to management servers 300a to 300c. Communicator 201 receives a response to the registration request from management servers 300a to 300c.

Controller 202 executes various types of processing based on the received information. Specifically, controller 202 stores the received information in storage. Controller 202 also executes processing for converting the received content data or the received design data into an NFT. The processing for conversion into an NFT is, for example, processing for causing communicator 201 to send a registration request regarding the NFT to management servers 300a to 300c.

First PF manager 203 manages detail enhancement service platform 10. First PF manager 203 provides detail enhancement service platform 10 to terminal 100a of creator 12 and terminal 100b of producer 11. First PF manager 203 stores the design data, the detail-enhanced content data, and the like.

Second PF manager 204 manages experiential commerce service platform 20. Second PF manager 204 provides experiential commerce service platform 20 to terminal 100b of producer 11 and terminal 100c of consumer 22. Of the detail-enhanced content data, second PF manager 204 stores content data used for the listing by producer 11.

Item manager 205 manages a real item associated with the NFT. In other words, item manager 205 stores an NFT ID for identifying the NFT, and an item ID for identifying a real item in association therewith. Item manager 205 may also store the owner of the item and a location of the item in real space (a storage location), also in association with the item ID.

FIG. 4 is a block diagram illustrating an example of the configuration of the management server according to the embodiment.

As illustrated in FIG. 4, each of management servers 300a to 300c includes communicator 301, controller 302, NFT issuer 303, and NFT manager 304.

Communicator 301 communicates with service server 200 or terminal 100b of producer 11. Communicator 301 receives a registration request for an NFT from service server 200 or terminal 100b. Communicator 301 sends a response to the registration request for the NFT to the device that sent the registration request for the NFT (service server 200 or terminal 100b).

Controller 302 executes various types of processing based on the received information.

NFT issuer 303 issues the NFT in response to the registration request for the NFT.

NFT manager 304 records the issued NFT in the distributed ledger. As a result, a block including the NFT is added to the blockchain.

### System Operations

Operations by system 1 having the foregoing configuration will be described next.

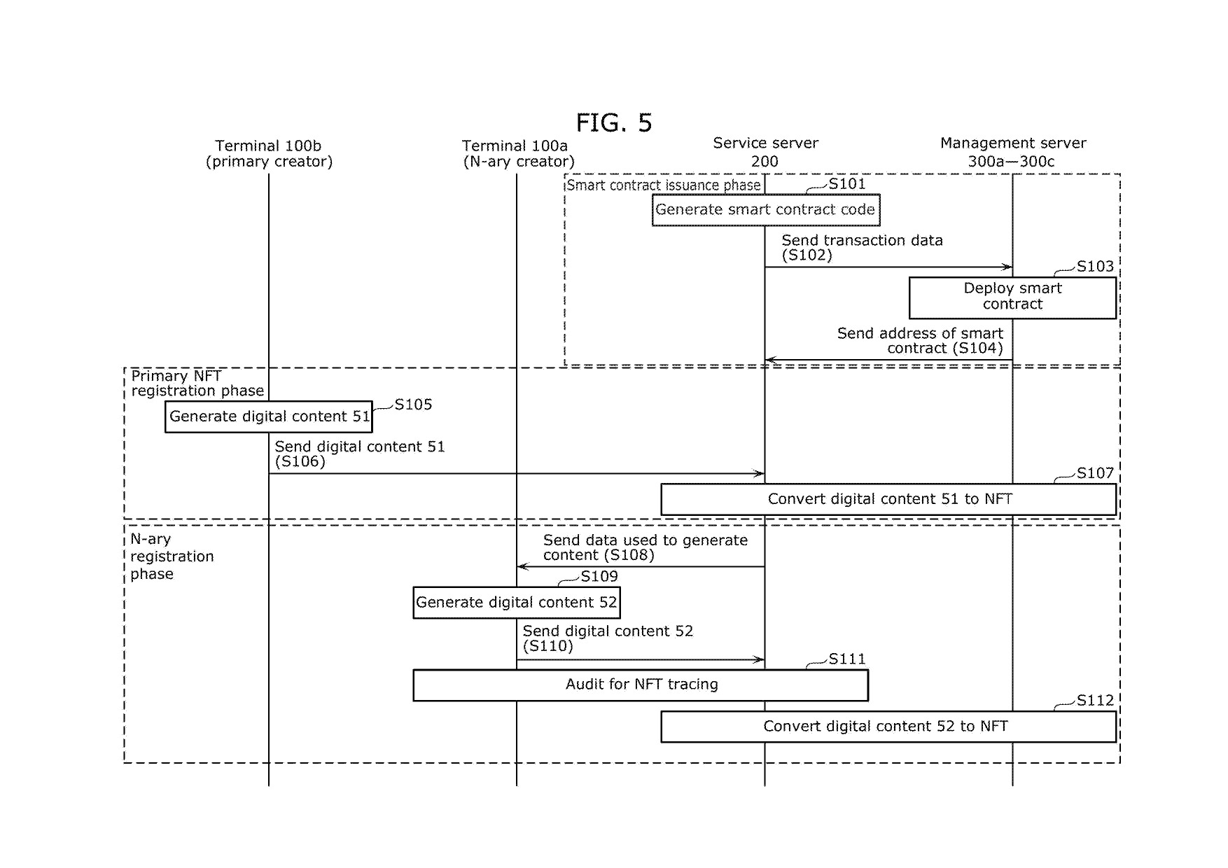

FIG. 5 is a sequence chart illustrating an example of processing for converting digital content to an NFT according to an embodiment.

First, a smart contract issuance phase in steps S101 to S104 is executed between service server 200 and management server 300a and the like.

Service server 200 generates a smart contract code (S101). The smart contract code is a code for, when transaction data including data such as digital content is stored in a blockchain system, implementing a smart contract for performing processing of automatically issuing an NFT of data.

Service server 200 generates transaction data including the generated smart contract code and sends the generated transaction data to management server 300a and the like (S102).

By storing the received transaction data in the blockchain managed by management server 300a and the like, management server 300a and the like deploy the smart contract represented by the smart contract code included in the transaction data (S103).

Once the smart contract is deployed, management server 300a sends the blockchain address where the smart contract is stored to service server 200 (S104).

Next, a primary NFT registration phase in steps S105 to S107 is executed between terminal 100b of producer 11, who serves as a primary creator, service server 200, and management server 300a and the like. In the primary NFT registration phase, an NFT of digital content 51 generated without using other digital content is registered, for example.

Terminal 100b generates digital content 51 (S105). Digital content 51 is design data, for example.

Terminal 100b sends digital content 51 to service server 200 (S106). As a result, service server 200 obtains digital content 51 generated by terminal 100b of producer 11.

Upon obtaining digital content 51, service server 200 executes processing for converting digital content 51 into an NFT with management server 300a and the like (S107).

Next, an N-ary registration phase in steps S108 to S112 is executed between terminal 100a of creator 12, serving as an N-ary creator (where N is a natural number of at least 2), service server 200, and management server 300a and the like. In the N-ary registration phase, an NFT of digital content 52 generated using other digital content such as digital content 51 is registered, for example. Digital content 52 may include a part of the other digital content, or may include a modified part of the other digital content. Digital content 52 may include some or all of a plurality of other digital content.

Service server 200 sends data used to generate the content to terminal 100a (S108). Step S108 may be executed in response to a request by terminal 100a. For example, by accessing service server 200 using terminal 100a, creator 12 selects one or more items of digital content used to generate the digital content creator 12 will generate, from among a plurality of items of digital content stored in service server 200. Terminal 100a then sends a request including information indicating the selected one or more items of digital content to service server 200. Through this, service server 200 may obtain the request from terminal 100a. Here, the selected one or more items of digital content may include digital content 51 generated without using other digital content, digital content generated using other digital content, or both types of digital content.

Terminal 100a generates digital content 52 (S109). Digital content 52 is, for example, content data produced by enhancing the detail of the design data.

Terminal 100a sends digital content 52 to service server 200 (S110).

Next, an audit for NFT tracing is performed between terminal 100a and service server 200 (S111), after which processing for converting digital content 52 into an NFT is executed between service server 200 and management server 300a and the like (S112).

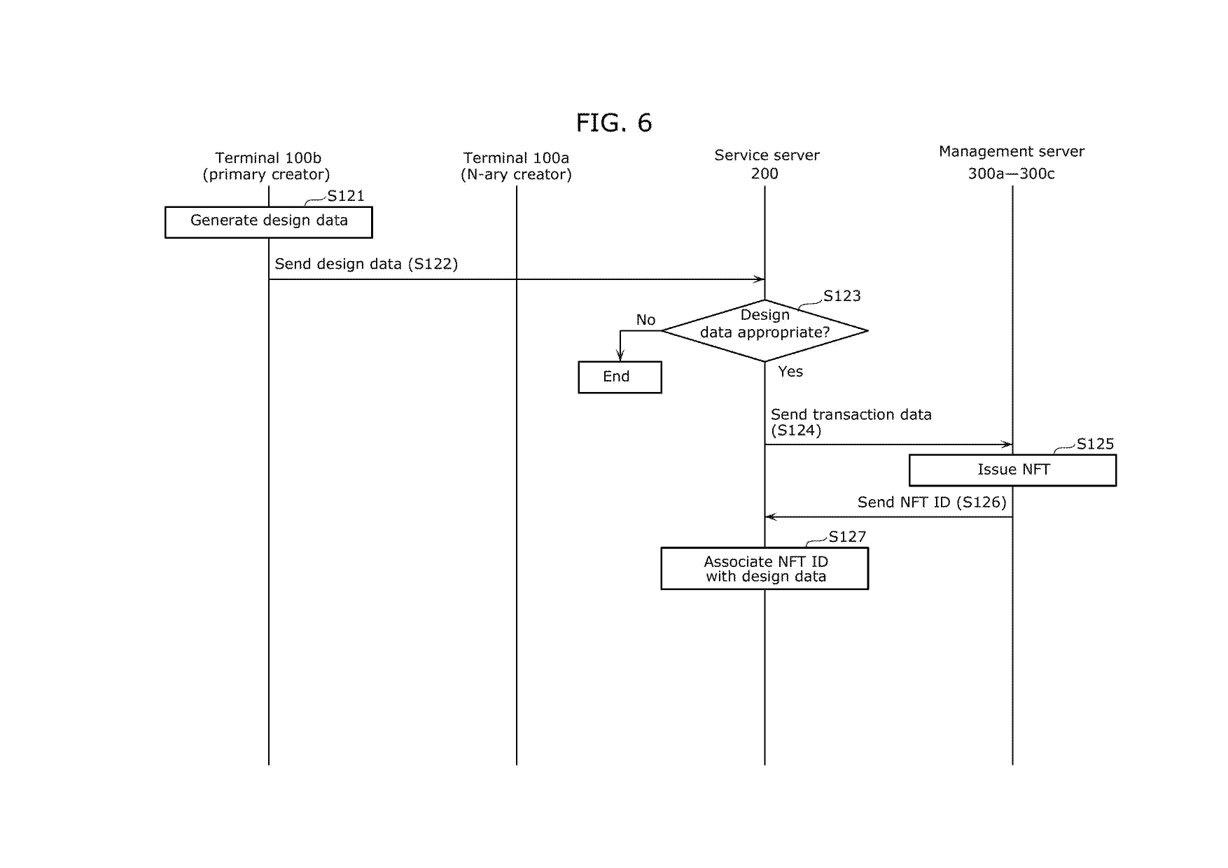

FIG. 6 is a sequence chart illustrating an example of details of the primary NFT registration phase according to the embodiment.

Terminal 100b generates design data as digital content 51 (S121). Step S121 corresponds to step S105.

Terminal 100b sends the design data to service server 200 (S122). Step S122 corresponds to step S106.

Upon obtaining the design data, service server 200 determines whether the obtained design data is appropriate (S123). Specifically, service server 200 determines whether the design data is appropriate as primary NFT content. Whether the design data is “appropriate” may be whether the design data is appropriate as primary NFT content.

Whether the design data is appropriate as primary NFT content may be determined according to different determination criteria depending on an attribute (e.g., the type) of the digital content. The primary NFT content may be determined to be appropriate as long as that content is digital content generated by a pre-approved primary creator. In other words, digital content associated with identification information identifying a designated primary creator may be determined to be appropriate as the primary NFT content.

Note that the primary NFT content is digital content generated without using other digital content. The primary NFT content is not limited to design data, and may be any digital content, such as three-dimensional content or video content.

If the design data is determined to be appropriate (Yes in S123), service server 200 executes step S124, whereas if the design data is determined not to be appropriate, the processing related to the design data ends.

In step S124, service server 200 sends metadata and transaction data including a Uniform Resource Identifier (URI) to management server 300a and the like (S124). The metadata includes the design data (digital content) for which the NFT is to be registered, for example. The URI indicates an address where the metadata is stored.

Management server 300a and the like issue a new NFT by storing the transaction data in the blockchain, executing the smart contract code for issuing an NFT, and generating a new NFT ID (S125). Management server 300a and the like may register the NFT in the blockchain by storing the issued NFT ID in the distributed ledger.

Management server 300a and the like send the issued NFT ID to service server 200 (S126).

Upon obtaining the NFT ID, service server 200 may store the obtained NFT ID in association with the design data (S127). Service server 200 may associate the NFT ID with the design data by adding the former to the latter as a digital watermark. If a file set including a plurality of files has been converted to an NFT, service server 200 may add the files. The plurality of files may be collected into a single group by means of a folder or the like, and the file sets included in a single group may be converted to an NFT. The plurality of files may represent a single item of design data, for example. When collected in a folder, the URL of the folder may be converted to an NFT. Additionally, a single compressed file generated by compressing a plurality of files may be converted to an NFT. In this manner, if a plurality of files are converted to an NFT, a new file (such as a text file) in which the NFT ID or smart contract address generated through the NFT conversion is recorded may be generated. If a plurality of files are collected in a folder, the new file may be stored within the folder, and if a plurality of files are compressed, the new file may be compressed along with the plurality of files. In this manner, a new file including the NFT ID and a plurality of files may be associated with each other.

Upon obtaining the NFT ID, service server 200 may notify terminal 100b of the obtained NFT ID.

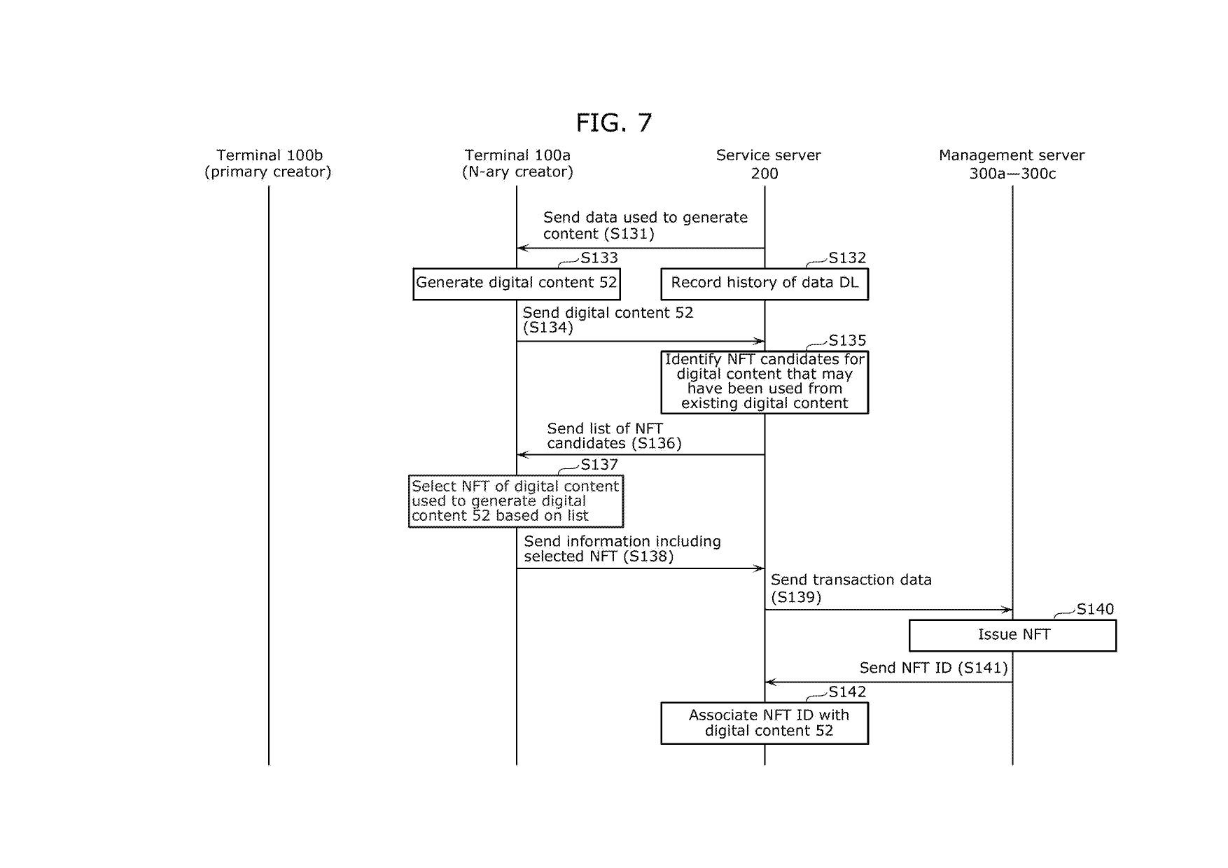

FIG. 7 is a sequence chart illustrating an example of details of the N-ary registration phase according to the embodiment.

Service server 200 sends data (digital content) used to generate the content to terminal 100a (S131). Step S131 corresponds to step S108. In other words, terminal 100a downloads the digital content from service server 200.

Service server 200 records a history of data downloads, which corresponds to the digital content downloaded by terminal 100a (S132).

Terminal 100a generates digital content 52 (S133). Step S133 corresponds to step S109.

Terminal 100a sends digital content 52 to service server 200 (S134). Step S134 corresponds to step S110. As a result, service server 200 obtains digital content 52 generated by terminal 100a of creator 12. Creator 12 is an example of a first user. Terminal 100a is an example of a first terminal.

Service server 200 identifies candidates for NFTs of digital content that may have been used in one or more items of existing digital content (S135). In other words, service server 200 identifies one or more items of first identification information associated with one or more items of existing digital content that may have been used by terminal 100a of creator 12 when generating digital content 52. The one or more items of first identification information are information indicating a candidate, and may be, for example, an NFT ID, or may be an ID different from the NFT ID. As long as the information indicates a candidate, the one or more items of first identification information are not limited to an ID, and may be a title of the digital content (text), or may be a hash value obtained by hashing the digital content corresponding to the identification information using a hash function.

Service server 200 may identify candidates for NFTs of digital content that may have been used in one or more items of existing digital content based on, for example, a history of digital content obtained by terminal 100a from service server 200. Service server 200 may also identify candidates for NFTs of digital content that may have been used in one or more items of existing digital content based on, for example, one or more NFT IDs included in digital content 52. In this case, digital content 52 may include one or more NFT IDs (one or more items of second identification information) of one or more items of other digital content used to generate digital content 52. For example, digital content 52 may include one or more NFT IDs (one or more items of second identification information) as digital watermarks.

Note that one or more items of existing digital content may include primary NFT content, or may include N-ary NFT content. The N-ary NFT content is digital content generated using at least the primary NFT content. For example, secondary NFT content is digital content generated using the primary NFT content, and tertiary NFT content is digital content generated using the secondary NFT content. In other words, the N-ary NFT content is content generated using (N−1)-ary NFT content. Accordingly, at least the secondary NFT content is generated using the primary NFT content, and thus the (N−1)-ary NFT content can be said to be generated using the primary NFT content. The NFT content is digital content subject to NFT conversion.

Service server 200 generates a list of the NFT candidates identified and sends the list of NFT candidates to terminal 100a (S136). In this manner, service server 200 outputs one or more items of first identification information. The list is a list for querying creator 12 about one or more items of other digital content used when generating digital content 52.

Upon obtaining the list of candidates for NFTs, terminal 100a selects the NFT of the digital content used to generate digital content 52 based on the obtained list (S137). For example, based on the list, terminal 100a displays a UI including candidates for digital content used by creator 12 to generate digital content 52.

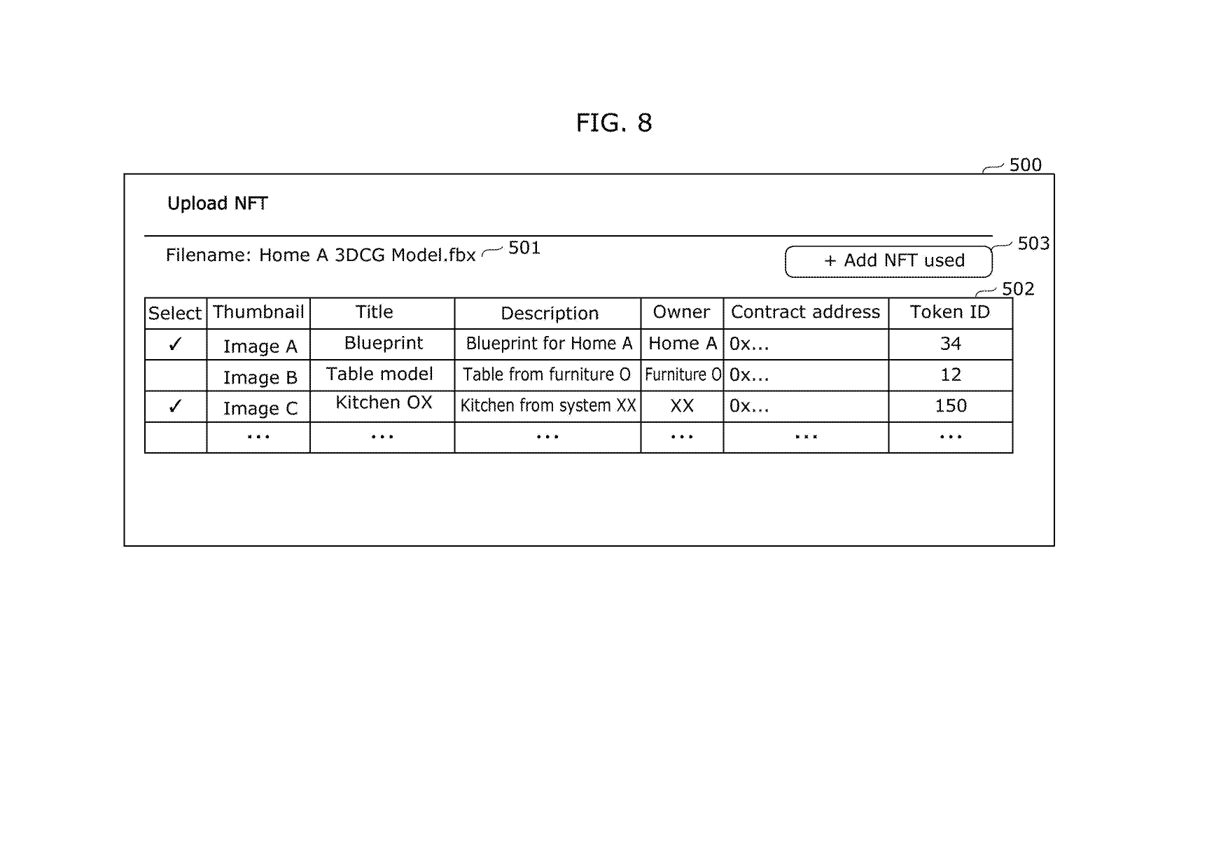

FIG. 8 is a diagram illustrating an example of the UI.

As illustrated in FIG. 8, the UI includes filename 501 of digital content 52 generated, table 502 showing a list of digital content used to generate digital content 52, and add button 503 for adding digital content not listed in table 502 to the list of used digital content. Digital content 52 may be paired with primary NFT content in advance. At this time, when that primary NFT content is downloaded, the location of a storage area in service server 200 for uploading digital content 52 generated using the primary NFT content may be designated. Digital content 52 is not limited to being paired with primary NFT content, and may be paired in advance with a generation of NFT content earlier than digital content 52.

Table 502 shows a plurality of candidates for digital content. In table 502, each item of digital content is indicated by a thumbnail, a title, a description, an owner, a contract address, and a token ID. The token ID is the NFT ID. In addition, each item of digital content is displayed with a checkmark in a selection field, indicating that the content was actually used by creator 12 in digital content 52. In other words, digital content having a checkmark is digital content selected as the digital content actually used by creator 12 to generate digital content 52, and digital content without a checkmark is digital content not selected as the digital content actually used by creator 12 to generate digital content 52.

In this manner, terminal 100a presents UI 500 and accepts a selection from creator 12 as the digital content used for digital content 52. The NFT of the digital content actually used to generate digital content 52 is selected as a result.

Terminal 100a sends information including the NFT of the selected digital content to service server 200 (S138). The information including the NFT of the selected digital content includes a response from creator 12 with respect to the list.

Note that if the NFT of the digital content used in the list is not included, creator 12 may use add button 503 to add the NFT of the digital content used. A check may also be entered in the list for the NFT of digital content that is likely to have been used in advance.

The digital content that is likely to have been used in advance may be primary NFT content that has been paired in advance, for example. Note that the digital content likely to have been used in advance is not limited to being paired with primary NFT content, and may be paired in advance with a generation of NFT content earlier than digital content 52. For example, when downloading NFT content from which content was generated from service server 200, terminal 100a submits an application to service server 200 in advance to generate secondary creative content based on the NFT content. Through this application, service server 200 can record the user ID indicating the user of terminal 100a in association with the content ID (NFT ID) of the NFT content to be downloaded. When terminal 100a uploads content generated through secondary creation by the user of terminal 100a to service server 200, service server 200 reads out the content ID (NFT ID) of the NFT content that was recorded in association with the user ID of the user, and displays the read-out content ID (NFT ID) with a checkmark in the list.

The digital content likely to have been used in advance may also be digital content obtained by inspecting three-dimensional CG, for example. For example, when terminal 100a uploads content generated through secondary creation by the user of terminal 100a to the service server, the service server scans the uploaded content and checks whether the information of other NFT content is included. The scanning is performed through a method that corresponds to the method through which service server 200 performed the association in step S127 and the like, such as using a digital watermark, a file containing NFT information, or the like. The NFT ID detected by the scanning is given a checkmark in the list.

The digital content likely to have been used in advance may also be digital content downloaded after downloading design data, for example. Service server 200 records a download history of downloads performed by terminal 100a in time series, and reads out the download history when necessary. If the download history includes the paired NFT content or the NFT content detected through the scan, after the NFT content has been downloaded by the user, terminal 100a displays the NFT content downloaded up to the time of the current content upload by adding checkmarks to the list.

The digital content that is likely to have been used in advance may also be digital content that has not been used (digital content that has not been selected) when uploading other digital content, for example. Service server 200 records the information of the NFT downloaded by terminal 100a (the NFT ID or the like) and information of the used NFT (the NFT ID or the like) declared at the time of upload. Here, if an NFT that is not included in the list of used NFTs is present in the list of NFTs downloaded by terminal 100a (i.e., if an NFT that has been downloaded but has not been used is present), when the user uploads new content, that new content is displayed in the list with a checkmark added for the corresponding NFT.

Conversely, a checkmark may be added to all digital content that is a candidate for the list in advance, and creator 12 may make an input to remove the checkmark by selecting digital content that has not been used. In this case, a checkmark need not be added to all digital content in advance, and the checkmarks may be removed from only digital content that has been used in other uploading for other NFT conversion.

When creator 12 selects the used digital content using UI 500, creator 12 may be limited to selecting the minimum number of items of digital content that need to be selected. In other words, the configuration may be such that the sequence does not advance to the next step unless at least a set number of items of digital content have been selected.

Upon obtaining information including the NFT of the selected digital content, service server 200 sends transaction data to management server 300a and the like (S139). The transaction data is generated by identifying, based on that information, one or more items of other digital content used by creator 12 when actually generating digital content 52. Service server 200 sends the metadata, the Uniform Resource Identifier (URI), and the transaction data including the NFT of the selected digital content to management server 300a and the like. The metadata includes digital content 52 for which the NFT is to be registered, for example. The URI indicates an address where the metadata is stored.

Management server 300a and the like issue a new NFT by storing the transaction data in the blockchain, executing the smart contract code for issuing an NFT, and generating a new NFT ID (S140). Management server 300a and the like may register the NFT in the blockchain by storing the issued NFT ID in the distributed ledger.

Management server 300a and the like send the issued NFT ID to service server 200 (S141).

Upon obtaining the NFT ID, service server 200 may store the obtained NFT ID in association with digital content 52 (S142). Service server 200 may associate the NFT ID with digital content 52 by adding the former to the latter as a digital watermark.

### Effects, Etc.

A control method performed by service server 200 (a device) according to the present embodiment includes: obtaining digital content 52 (first digital content) generated by terminal 100a (a first terminal) of creator 12 (a first user) (S134); identifying one or more NFT IDs (one or more items of first identification information) associated with one or more items of other digital content (one or more items of second digital content) that may have been used in generation of digital content 52 by terminal 100a of creator 12 (S135); and outputting the one or more NFT IDs (one or more items of first identification information) identified.

Accordingly, one or more NFT IDs associated with one or more items of other digital content that may have been used when generating digital content 52 can be used as candidates for the digital content used when generating digital content 52. By presenting one or more NFT IDs that are candidates for one or more items of other digital content to creator 12 of digital content 52, creator 12 can easily identify the digital content used when generating digital content 52, and can easily declare the digital content used when generating digital content 52.

In the control method according to the present embodiment, the one or more NFT IDs serving as candidates are identified based on a history of digital content obtained from service server 200 by terminal 100a.

Accordingly, one or more NFT IDs associated with one or more items of other digital content that are likely to have been used when generating digital content 52 can be identified with ease.

In the control method according to the present embodiment, digital content 52 includes one or more NFT IDs (one or more items of second identification information). The one or more NFT IDs serving as candidates (one or more items of first identification information) are identified based on the one or more NFT IDs included in digital content 52 (the one or more items of second identification information).

Accordingly, one or more NFT IDs (one or more items of first identification information) associated with one or more items of other digital content that are likely to have been used when generating digital content 52 can be identified with ease by analyzing digital content 52.

The control method according to the present embodiment further includes generating a list including the one or more NFT IDs (one or more items of first identification information), the list being a list for querying creator 12 about one or more items of third digital content used when generating digital content 52, and sending the list to terminal 100a.

Accordingly, because one or more NFT IDs (one or more items of first identification information) can be presented to creator 12 of digital content 52 as a list, creator 12 can easily identify the existing digital content used when generating digital content 52 from the list, and can easily declare the digital content used when generating digital content 52.

The control method according to the present embodiment further includes receiving a response to the list from terminal 100a, and identifying, in accordance with the response, one or more NFT IDs (one or more items of third identification information) corresponding to the one or more items of third digital content.

Accordingly, a response from creator 12 can be used as a declaration of digital content used when generating digital content 52, and one or more items of third digital content used when generating digital content 52 can be identified with ease.

The control method according to the present embodiment further includes generating transaction data including digital content 52 and the one or more NFT IDs (one or more items of third identification information), and causing a blockchain system to issue an NFT corresponding to the digital content by sending the transaction data to the blockchain system. The NFT includes the one or more NFT IDs (one or more items of third identification information).

Accordingly, an NFT associated with digital content 52, the NFT including one or more NFT IDs (one or more items of third identification information) associated with one or more items of third digital content, can be generated with ease.

The control method according to the present embodiment further includes obtaining an NFT ID of the NFT corresponding to digital content 52 from the blockchain system and storing the NFT ID in association with digital content 52.

Accordingly, digital content 52 and the NFT ID of the NFT issued by the blockchain system can be stored in association with each other.

In the control method according to the present embodiment, the one or more NFT IDs (one or more items of first identification information) include a fourth NFT ID (fourth identification information) and a fifth NFT ID (fifth identification information). The fourth NFT ID is associated with fourth digital content, and the fifth NFT ID is associated with fifth digital content. The fourth digital content is more likely than the fifth digital content to have been used to generate the first digital content. The list further includes information indicating that the fourth digital content is more likely than the fifth digital content to have been used to generate digital content 52.

Accordingly, a list including a fourth NFT ID of fourth digital content that is likely to have been used and a fifth NFT ID of the fifth digital content that is less likely to have been used than the fourth digital content can be presented to creator 12 of digital content 52. Accordingly, creator 12 can easily identify the digital content used when generating digital content 52 from the list, and can easily declare the digital content used when generating digital content 52.

### Variations

Although the foregoing embodiment described enhancing the detail of three-dimensional digital content as an example of generating new digital content using other digital content, the detail of two-dimensional digital content may be enhanced as well. Furthermore, beyond enhancing the detail of digital content, new digital content may be generated by cutting out and combining parts of streamed content in a timewise manner, or new digital content may be generated by cutting out and combining parts in a spatial manner.

### Supplemental Descriptions

Supplemental descriptions of the distributed ledger used in the foregoing embodiment or variations will be given next. Although a blockchain is described here as an example of a distributed ledger, the same applies to other distributed ledgers as well.

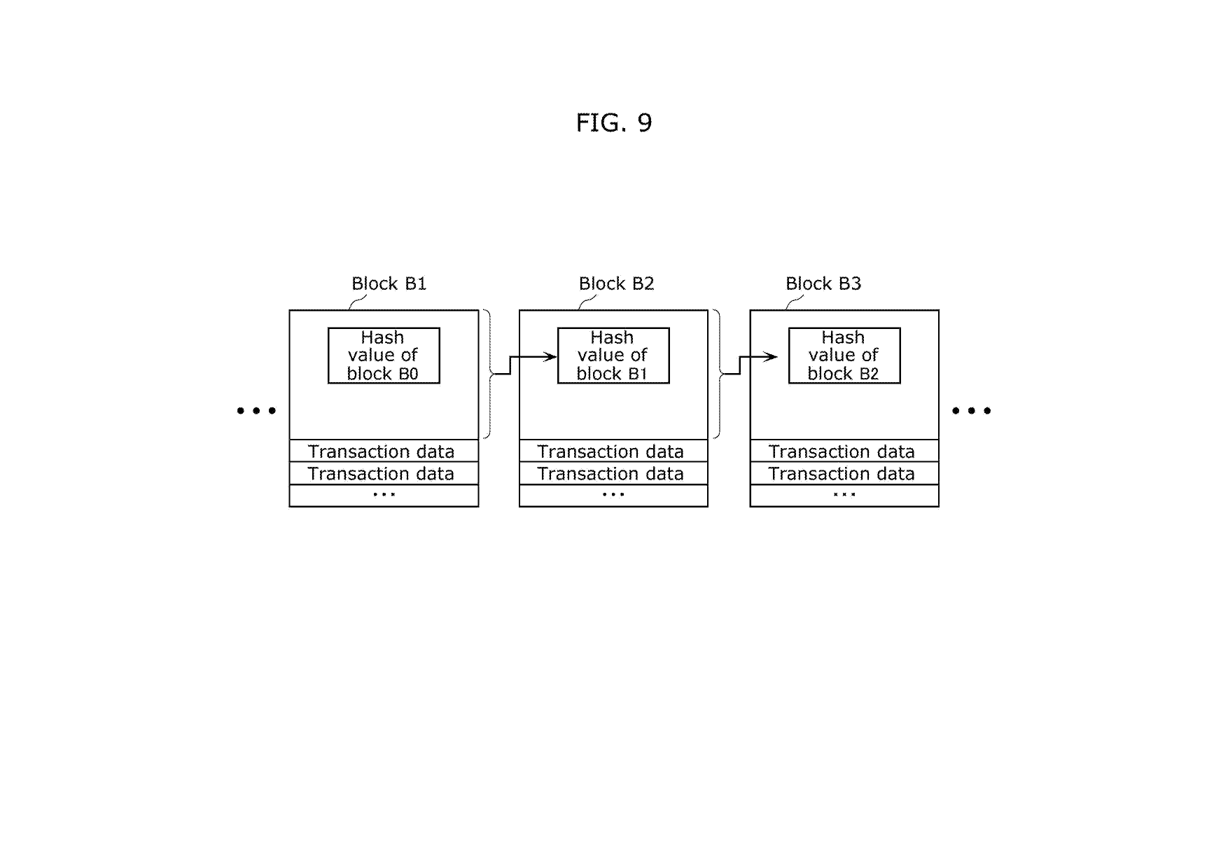

FIG. 9 is an explanatory diagram illustrating the data structure of a blockchain.

A “blockchain” is a connection of blocks, which serve as a unit of record, in the form of a chain. Each block includes a plurality of instances of transaction data and a hash value of the block immediately previous in the chain. Specifically, block B2 includes the hash value of block B1, which is immediately previous in the chain. A hash value computed from the plurality of instances of transaction data included in block B2 and the hash value of block B1 is then included in block B3 as the hash value of block B2. Connecting the blocks in a chain with each block including the details of the previous block as a hash value in this manner makes it possible to effectively prevent tampering with the recorded transaction data.

If, for example, a past instance of transaction data has been changed, the hash value of the block will have a value different from the pre-change value. This means that to make a block which has been tampered with appear normal, it is necessary to rebuild all the blocks previous thereto, which is a task that is extremely difficult in practice. This characteristic is used to ensure that it is difficult to tamper with the blockchain.

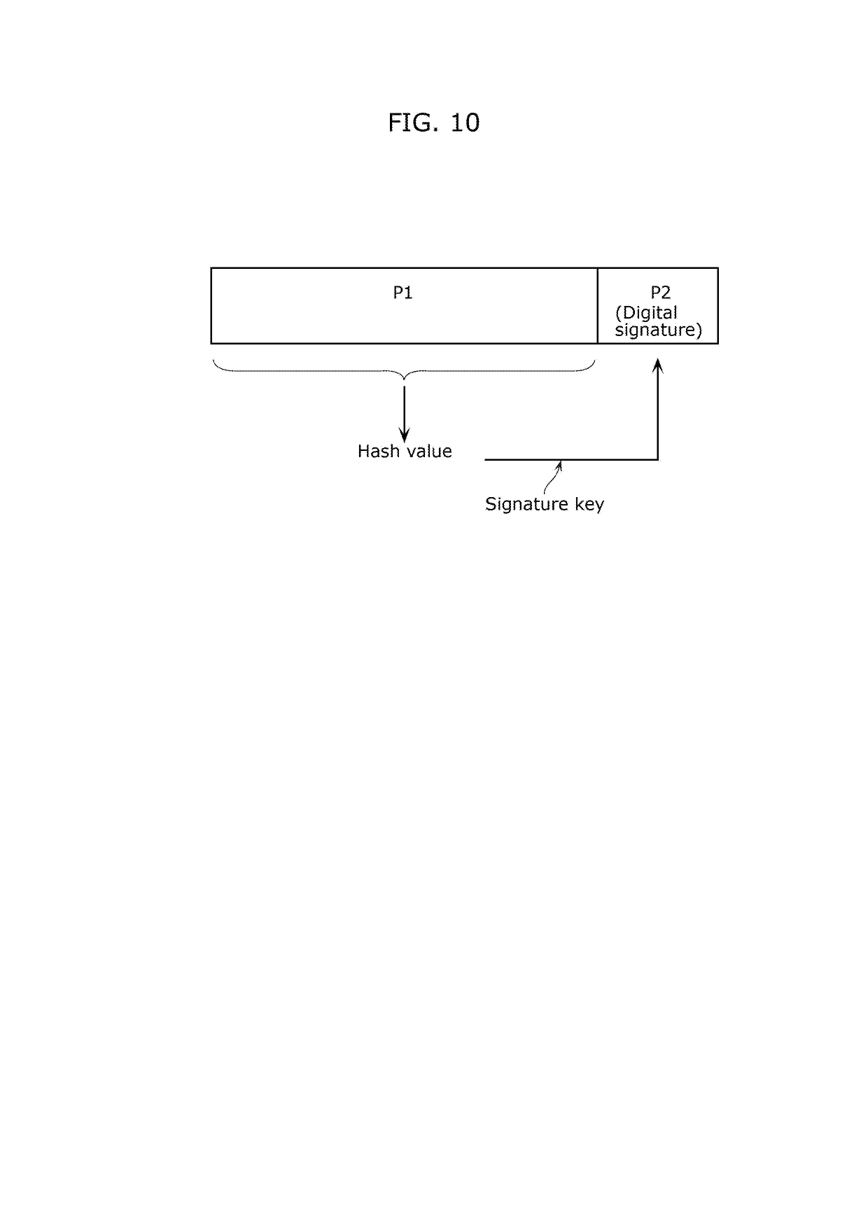

FIG. 10 is an explanatory diagram illustrating the data structure of transaction data.

The transaction data illustrated in FIG. 10 contains main transaction part P1 and digital signature P2. Main transaction part P1 is the main data of that transaction data. Digital signature P2 is a digital signature generated using a signature key of the creator of the transaction data on the hash value of main transaction part P1, and more specifically, is generated by encrypting the hash value using a private key of the creator of the transaction data. The digital signature method is, for example, the Elliptic Curve Digital Signature Algorithm (ECDSA), CRYSTALS-Dilithium, Falcon, SPHINCS+, or the like.

The transaction data has digital signature P2 and is therefore substantially impossible to be tampered with. This is because if the transaction data is tampered with, verification using digital signature P2 will fail, making it clear that the transaction data has been tampered with. This prevents main transaction part P1 itself from being tampered with.

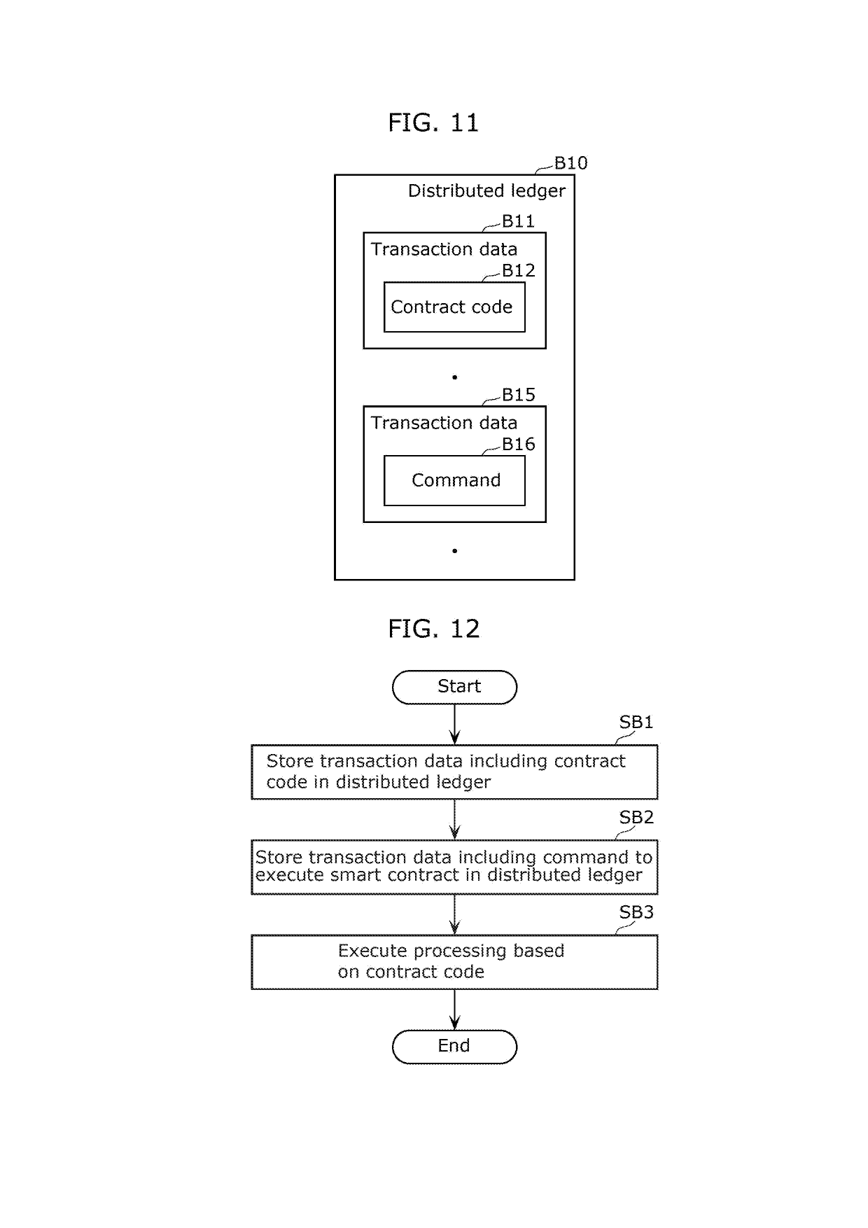

FIG. 11 is an explanatory diagram illustrating transaction data related to the execution of a smart contract. FIG. 12 is an explanatory diagram illustrating processing related to the execution of a smart contract.

A series of processing for executing a smart contract using a distributed ledger will be described with reference to FIGS. 11 and 12.

In step SB1, a node stores transaction data B11, including contract code B12 describing the processing of the smart contract, in distributed ledger B10. For example, the node obtains transaction data B11 by receiving transaction data B11 through communication from an information processing device, or by the node itself generating transaction data B11, and stores transaction data B11 obtained in distributed ledger B10. Step SB1 is performed before executing the smart contract.

In step SB2, the node stores transaction data B15, including command B16 to execute the smart contract, in distributed ledger B10. For example, the node receives transaction data B15 through communication from an information processing device, and stores transaction data B15 received in distributed ledger B10.

In step SB3, the node reads out contract code B12 from distributed ledger B10 in response to transaction data B15, including command B16, being stored in distributed ledger B10 in step SB2, and executes processing based on contract code B12. The result of the processing may be included in the transaction data and stored in distributed ledger B10.

Through the foregoing series of processing, when transaction data B15 including command B16 to execute the smart contract is received, the distributed ledger system automatically (i.e., without requiring work to be performed by a person) executes processing in accordance with command B16, and thus the processing can be executed with a high level of efficiency (i.e., quickly, or in a short period of time). Implementing highly-efficient processing has the effect of reducing power consumption. In addition, because work by a person is not required, situations where a person tampers with the information, acts improperly, or makes a human error can be avoided. Furthermore, the result of the processing executed in this manner is stored in the blockchain, which can make it substantially impossible for the result of the processing to be tampered with.

In the foregoing embodiment and variations, the constituent elements are constituted by dedicated hardware. However, the constituent elements may be realized by executing software programs corresponding to those constituent elements. Each constituent element may be realized by a program executing unit such as a CPU or a processor reading out and executing a software program recorded into a recording medium such as a hard disk or semiconductor memory. Here, the software that realizes the information processing device (i.e., a virtual space management server) and the like according to the foregoing embodiment and variations is a program such as that described below.

In other words, this program is a program for causing a computer to execute a control method performed by a device, the control method including obtaining first digital content generated by a first terminal of a first user identifying one or more items of first identification information associated with one or more items of second digital content that may have been used in generation of the first digital content by the first terminal of the first user, and outputting the one or more items of first identification information identified.

An information processing device (i.e., a virtual space management server) and the like according to one or more aspects have been described based on an embodiment, but the present disclosure is not limited to this embodiment. Variations on the embodiment conceived by one skilled in the art, embodiments implemented by combining constituent elements from different other embodiments, and the like may be included in the scope of one or more aspects as well, as long as they do not depart from the essential spirit of the present disclosure.

### INDUSTRIAL APPLICABILITY

The present disclosure can be used as a control method and the like capable of easily identifying candidates for digital content used to generate digital content.

1. A control method performed by a device, the control method comprising:
obtaining first digital content generated by a first terminal of a first user;
identifying one or more items of first identification information associated with one or more items of second digital content that may have been used in generation of the first digital content by the first terminal of the first user; and
outputting the one or more items of first identification information identified.

2. The control method according to claim 1,
wherein the one or more items of first identification information are identified based on a history of digital content obtained from the device by the first terminal.

3. The control method according to claim 1,
wherein the first digital content includes one or more items of second identification information, and
the one or more items of first identification information are identified based on the one or more items of second identification information included in the first digital content.

4. The control method according to claim 1, further comprising:
generating a list including the one or more items of first identification information, the list being a list for querying the first user about one or more items of third digital content used when generating the first digital content; and
sending the list to the first terminal.

5. The control method according to claim 4, further comprising:
receiving a response to the list from the first terminal; and
identifying, in accordance with the response, one or more items of third identification information corresponding to the one or more items of third digital content.

6. The control method according to claim 5, further comprising:
generating transaction data including the first digital content and the one or more items of third identification information; and
causing a blockchain system to issue a non-fungible token (NFT) corresponding to the first digital content, by sending the transaction data to the blockchain system,
wherein the NFT includes the one or more items of third identification information.

7. The control method according to claim 6, further comprising:
obtaining an NFT ID of the NFT from the blockchain system; and
storing the NFT ID in association with the first digital content.

8. The control method according to claim 4,
wherein the one or more items of first identification information include fourth identification information and fifth identification information,
the fourth identification information is associated with fourth digital content,
the fifth identification information is associated with fifth digital content,
the fourth digital content is more likely than the fifth digital content to have been used to generate the first digital content, and
the list further includes information indicating that the fourth digital content is more likely than the fifth digital content to have been used to generate the first digital content.

9. A device comprising:
a processor; and
a memory,
wherein using the memory, the processor:
obtains first digital content generated by a first terminal of a first user;
identifies one or more items of first identification information associated with one or more items of second digital content that may have been used in generation of the first digital content by the first terminal of the first user; and
outputs the one or more items of first identification information identified.

10. A non-transitory computer-readable recording medium having recorded thereon a program for causing a computer to execute a control method performed by a device, the control method comprising:
obtaining first digital content generated by a first terminal of a first user;
identifying one or more items of first identification information associated with one or more items of second digital content that may have been used in generation of the first digital content by the first terminal of the first user; and
outputting the one or more items of first identification information identified.
